(19) United States
(12) Patent Application Publication
(10) Pub. No.: US 2007/0189510 A1
(43) Pub. Date: Aug. 16, 2007

(54) Data collector

(75) Inventors: Hiroyasu Tanaka, Zama-shi (JP); Takuichiro Inoue, Fujisawa-shi (JP); Youhei Ishikawa, Zama-shi (JP); Yasuhiro Tani, Atsugi-shi (JP); Toshiji Iida, Sagamihara-shi (JP)

Correspondence Address: FOLEY AND LARDNER LLP;SUITE 500, 3000 K STREET NW, WASHINGTON, DC, 20007, US

(73) Assignee: JATCO Ltd

(21) Appl. No.: 11/212,666

(22) Filed: Aug. 29, 2005

(30) Foreign Application Priority Data
Aug. 30, 2004 (JP) 2004-250434

(51) Int. Cl. H04L 9/28

(52) U.S. Cl. 380/28

(57) ABSTRACT

Disclosed is a data collector that collects a first data string sent by a control unit to a network according to a predetermined format. The control unit has a first identification number, and the first data string includes the first identification number and a parameter which is used to control a vehicle or a vehicle component. The data collector includes a first collecting means for collecting the first data string sent by the control unit; and a second collecting means for collecting a second data string sent by a data converter. The data converter has a second identification number different from the first identification number of the control unit and the second data string conforms to the predetermined format. The data converter converts analog data sent from a sensor that detects a driving condition of the vehicle into digital data, puts the second identification number and the digital data in the second data string to be sent, and sends the second data string at a predetermined interval.

### FIELD OF THE INVENTION

This invention relates to a data collector for a vehicle, and more particularly to a data collector connected to a controller area network (CAN) for a vehicle.

### BACKGROUND OF THE INVENTION

Japanese examined patent application publication JP 06-83217 B published in 1994 discloses a data converter which converts an analog detection signal from a sensor into digital data, and a data collector which collects the digital data sent to a controller area network (CAN) as CAN data. The CAN is described in detail in the website (http://www.can-cia.de/) of CAN in Automation (CiA) (the international users'and manufacturers'organization that develops and supports CAN-based higher-layer protocols).

However, in the above-mentioned conventional technique, control units for controlling a vehicle or components of a vehicle send digital data, which is analog-to-digital (A/D) converted by the data converter, to the CAN as CAN data. The CAN data which is sent to the CAN via the control units may include an error or may not include necessary information because of a failure in the control units.

Further, in the conventional technique, digital data sent from the data converter is recorded in the control units serving as data collectors, which are connected to the CAN, and is analyzed by the control units. Since an analyzer including the control units serving as data collectors becomes large as a whole, there arises a problem in that a work space in a test vehicle is limited, for example.

### SUMMARY OF THE INVENTION

It is therefore an object of this invention to reduce an error in CAN data corresponding to an analog detection signal from a sensor and to miniaturize a data collector.

In order to achieve the above object, this invention provides a data collector that collects a first data string sent by a control unit to a network according to a predetermined format, the control unit having a first identification number, and the first data string including the first identification number and a parameter which is used to control a vehicle or a vehicle component. The data collector comprises a first collecting means for collecting the first data string sent by the control unit; and a second collecting means for collecting a second data string sent by a data converter. The data converter has a second identification number different from the first identification number of the control unit, and the second data string conforms to the predetermined format. The data converter converts analog data sent from a sensor that detects a driving condition of the vehicle into digital data, puts the second identification number and the digital data in the second data string to be sent, and sends the second data string at a predetermined interval.

Further, this invention provides a network used in a vehicle. The network comprises a plurality of control units that connect with the network and send data strings according to a predetermined format to the network. Each of the plurality of control units has a unique identification number and each of the data strings includes the identification number and a parameter which is used to control the vehicle or a component of the vehicle. The network further comprises a sensor that detects a driving condition of the vehicle; a first channel that collects the data strings sent by the plurality of control units; and a second channel that collects a data string sent by a data converter having an identification number different from those of the plurality of control units. The data string conforms to the predetermined format. The data converter converts analog data sent from the sensor into digital data, puts the identification number of the data converter and the digital data in the data string to be sent, and sends the data string to the second channel at a predetermined interval.

The details as well as other features and advantages of this invention are set forth in the remainder of the specification and are shown in the accompanying drawings.

### BRIEF DESCRIPTION OF THE DRAWINGS

FIG. 1 shows an example of a network including a data collector.

FIG. 2 is a block diagram showing a configuration of a data converter.

FIG. 3 shows another example of a network including data collectors.

FIG. 4 is an exploded view of the data collector divided into a case and an electronic-components assembly.

FIG. 5 is a perspective view of the electronic-components assembly.

FIG. 6 is a top view of the data collector.

FIG. 7 is a bottom view of the data collector.

FIG. 8 is a sectional view of the data collector, taken along the line A-B shown in FIG. 6. Here, a terminal for obtaining electric power is not shown.

FIG. 9 is a sectional view of the data collector, taken along the line A-A shown in FIG. 6.

### DETAILED DESCRIPTION OF THE PREFERRED EMBODIMENT

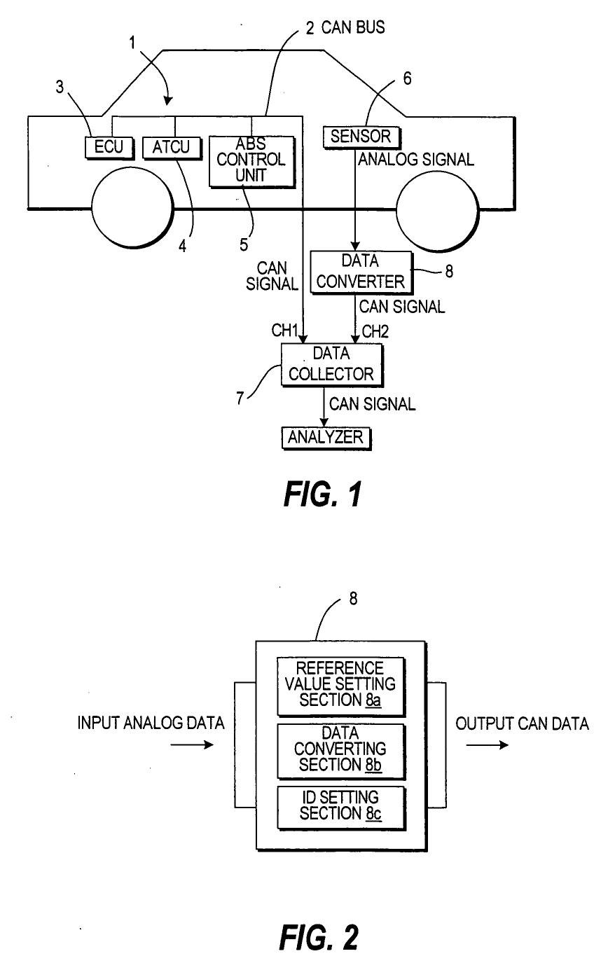

FIG. 1 shows an example of a network including a data collector according to this invention. A network 1 is configured in a vehicle or a mobile body by using a controller area network (CAN) protocol.

Components connected to a bus (hereinafter, referred to as a CAN bus) 2 of the network 1 are an electronic control unit (ECU) 3 for controlling the operation of an engine, a transmission control unit (ATCU) 4 for controlling an automatic transmission, and an anti-lock brake system (ABS) control unit 5 for controlling the ABS. The control units 3, 4, and 5 control the vehicle and/or components of the vehicle. Each of the control units 3, 4, and 5 sends to a common network 1 a data string according to a predetermined CAN format (CAN message frame format). The data string includes a parameter, which is used to control the vehicle or a component of the vehicle, and an identification number. A CAN signal is sent from the control units 3, 4, and 5 to a first channel CH1 of a data collector 7 via the CAN bus 2. Meanwhile, a sensor (detection device) 6 is provided to detect a driving state of the vehicle in which the network 1 is installed. A data converter 8 converts an analog signal output from the sensor 6 into a digital signal, and further converts the digital signal into a CAN signal, which is a kind of a digital signal. The data converter 8 is a component which sends the CAN signal to a second channel CH2 of the data collector 7 at a predetermined interval (for example, 1 millisecond). The data converter 8 may send the CAN signal to the CAN bus 2. The predetermined interval is set according to a transmission load of the CAN bus 2. The predetermined interval is set longer if the load is high, and is set shorter if the load is low. The CAN signal from the CAN bus 2 and the CAN signal from the data converter 8 are collected by different channels, so the load of the CAN bus 2 can be reduced and ID interference between the data converter 8 and the CAN bus 2 is prevented.

The data collector 7 identifies an identification number or an identification signal (ID) contained in a sent data string, collects a CAN signal corresponding to the identification number, and stores the CAN signal in an attached removable external storage medium (or external storage device). The data collector 7 includes a writer/reader, an interface, or a drive serving as a unit for writing/reading data into/from the external storage medium. The external storage medium stores data strings sent from the plural control units and a data string sent from the data converter 8. The data string sent from a control unit is referred to as a first data string and the data string sent from the data converter 8 is referred to as a second data string. The data collector 7 may include a single external storage medium. For example, the external storage medium is a flash memory card such as a CompactFlash (CF) card (the CompactFlash is a trademark registered by SanDisk). For data analysis, only the flash memory card is removed after data collection, and is connected to a separately provided analyzer. Since all stored data conforms to the same CAN format, analysis is simplified and the efficiency of the analysis can be improved.

A predetermined ID is assigned to each of the components connected to the data collector 7. Any ID can be assigned to the data converter 8 and the data converter 8 assigns to the sensor 6 an ID other than the assigned IDs. The data collector 7 collects necessary data by identifying data strings on the CAN bus based on the IDs.

Each of the plural control units 3, 4, and 5 is a microcomputer-based controller. Each control unit is provided with a microcomputer including a central processing unit (CPU) for executing a program, a read-only memory (ROM) for storing the program and data, a random access memory (RAM) for temporarily storing calculation results of the CPU and obtained data, and an input/output interface (I/O interface).

Referring to FIG. 2, the data converter 8, which samples an analog signal from the sensor 6 to convert it into a CAN signal, will be described. The data converter 8 is composed of a reference value setting section 8a for setting a reference output value, a data converting section 8b for calculating an output value with respect to an input value from the sensor 6 and converting the output value into CAN data according to the CAN format, and an ID setting section 8c for setting an ID for the CAN data to be output.

The data converter 8 is provided with a microprocessor and a memory. The reference value setting section 8a, the data converting section 8b, and the ID setting section 8c may be configured by a program executed by the microprocessor.

The reference value setting section 8a sets an output value of the sensor 6 obtained before measurement as a first reference value (or a zero point) and further sets another output value as a second reference value. The second reference value is preferably set to a value corresponding to the maximum output value. Not limited to this, the second reference value may be an output value easy for a target sensor to output. For example, if the sensor 6 is an acceleration sensor (G sensor), the second reference value may be an output value (output voltage) corresponding to a measured acceleration value 1 G.

The data converting section 8b assumes that a linear relationship is established between measurement values and sensor output values in the range between the set first and second reference values. For example, using the linear relationship, the data converting section 8b converts a voltage output from the acceleration sensor into acceleration (G) and outputs it as CAN data. In order to take measures against a rapid change of the analog signal, the data converting section 8b sets a sampling rate (detection rate) for the analog signal from the sensor 6 faster than the sampling rate of the data collector 7 for the CAN signal from the data converter 8. Accordingly, phase shifting and aliasing are prevented, so that the data collector 7 can simultaneously record the CAN signals from the control units as well as the CAN signal from the data converter 8. For example, when the sampling rate for the CAN signal is 100 Hz, the sampling rate for the analog signal is set to 1 kHz. The sampling rate for the analog signal may be about five times the sampling rate for the CAN signal.

The ID setting section 8c sets an identification number ID used to identify CAN data. An ID for the data converter 8 is set to an ID which is not used by the control units. The set ID and CAN data are sent to the data collector 7 as a data string conforming to the CAN format.

The data converter 8 may convert a sampled analog signal into a digital (CAN) signal, and inversely convert a digital signal into an analog signal. Accordingly, the data converter 8 can function as a controller of the sensor 6.

A connector on an output side of the data converter 8 may be directly connected to a connector 28a of the data collector 7 without a signal cable, and thus the data collector 7 and the data converter 8 may be integrally configured. This integrated configuration saves a space.

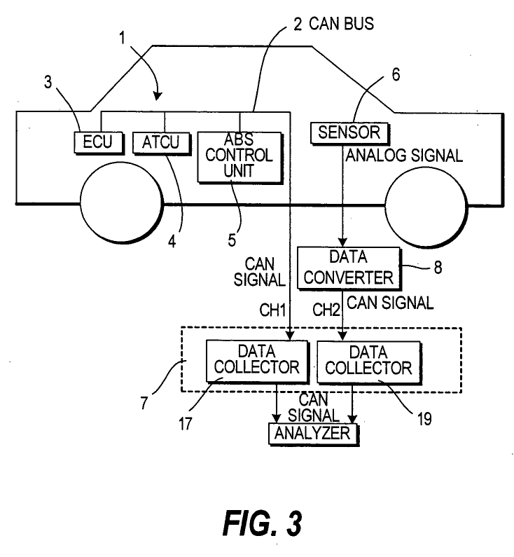

Referring to FIG. 3, a signal from the CAN bus and a CAN signal into which an analog signal is converted by the data converter 8 are not collected by the single data collector 7, but may be collected by a first data collector 17 and a second data collector 19. An external storage medium in the first data collector 17 is associated with the first channel so as to store data strings sent by the plural control units, and an external storage medium in the second data collector 19 is associated with the second channel so as to store a data string sent by the data converter. In this case, the transmission load of the bus is reduced and the data collection capacity is increased. The data collected by the different data collectors can be analyzed by being synthesized. Each of the first data collector 17 and second data collector 19 includes a writer/reader for an external storage medium. It should be noted that the first data collector 17 and second data collector 19 may be collectively regarded as one data collector 7.

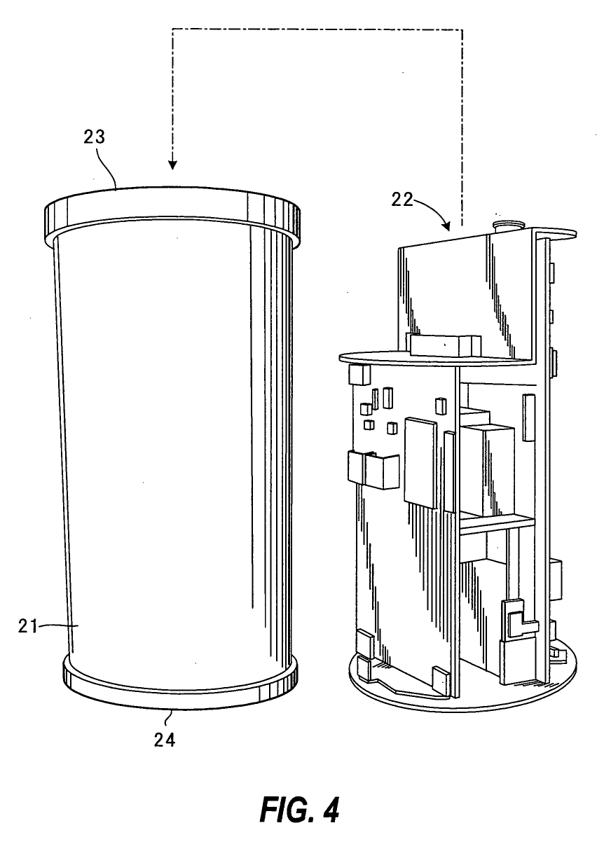

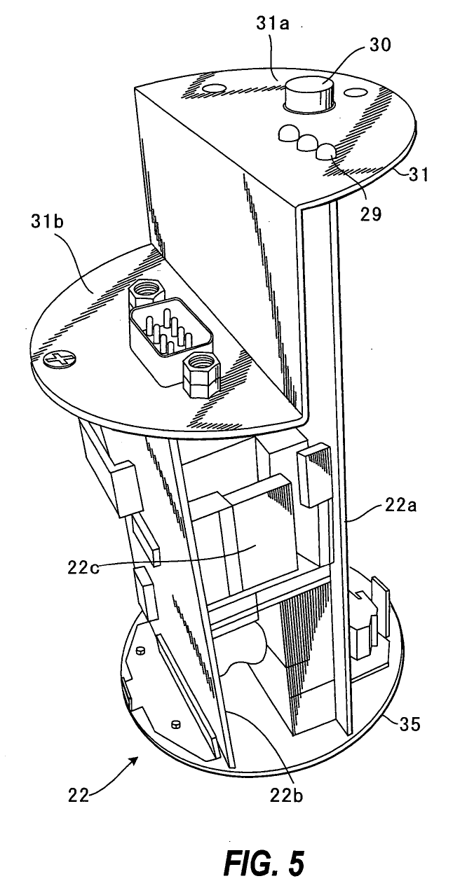

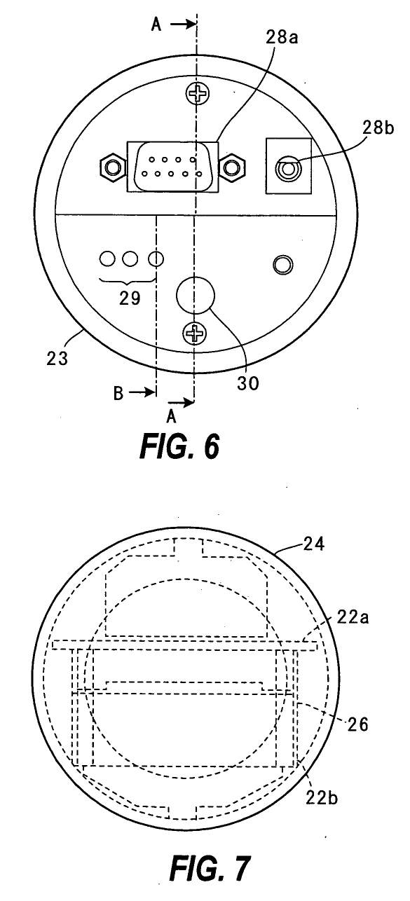

FIGS. 4 and 5 illustrate a structure of the data collector 7. The data collector 7 collects CAN data, and stores CAN data in a flash memory card 25 serving as an external storage medium. For data analysis, only the flash memory card 25 is removed and data is input to the analyzer from the flash memory card 25. Thus, it is not required to install an analyzer on test vehicles, and only the installation of the data collector 7 is required. The data collector 7 is small in dimension, so it is easy to install in a limited space on the test vehicles.

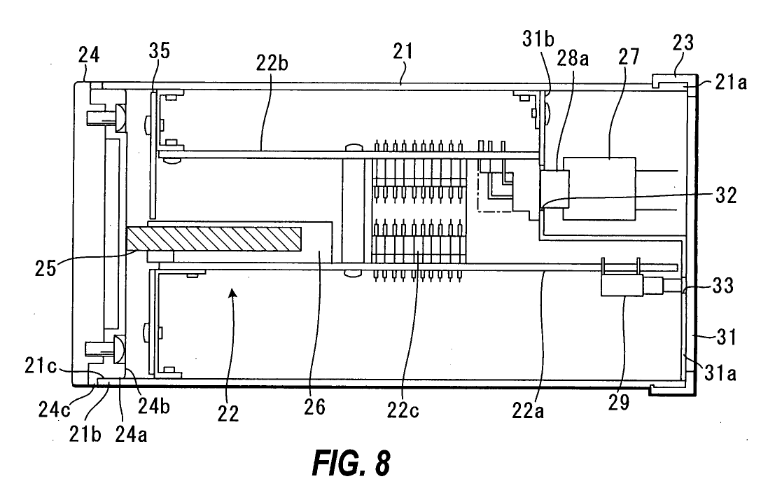

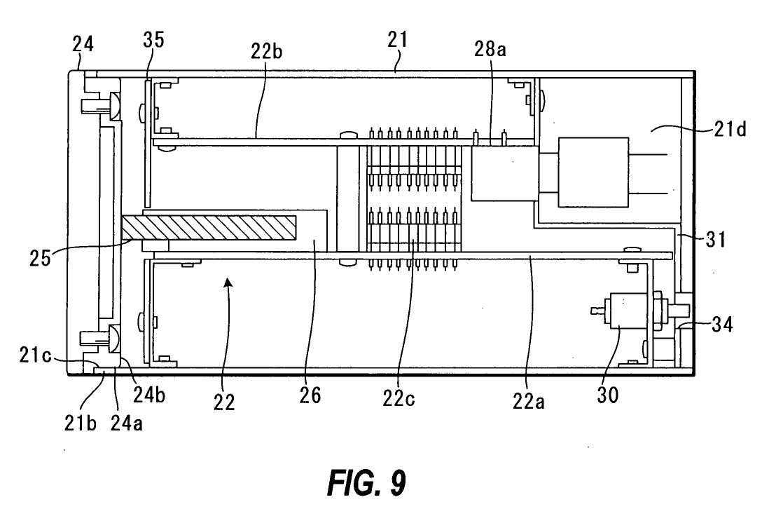

A case 21 of the data collector 7 is formed of an aluminum thin plate member and has a substantially cylindrical shape, and thus it is light in weight and easy to hold. Referring to FIG. 8, one end 21a of the case 21 is covered with a ring-like cover 23 made of a rubber material. The cover 23 prevents a sharp edge of the end 21a from damaging other components. Even when the inside of the vehicle reaches a high temperature, the data collector 7 is easy to handle by holding the cover 23.

On the other hand, female screws 21c are formed on an inner circumference of the other end 21b side. On the other end 21b of the case 21, a bottom lid 24 having male screws 24a which are engaged with the female screws 21c is mounted. A flange part 24c of the bottom lid 24 is provided to cover a sharp edge of the other end 21b of the case 21. The outer diameter of the flange part 24c is substantially equal to that of the case 21. The bottom lid 24 presses the bottom of the flash memory card 25 which is inserted in an electronic-components assembly 22.

The outer diameter of the cylindrical case 21 is substantially the same as or a little smaller than the outer diameter (about 6.5 centimeters) of an ordinary 350-milliliter can. Thus, the data collector 7 can be accommodated in a so-called cup holder provided for the compartment of the vehicle. Therefore, there is no need to find a place to put the data collector 7 and the data collector is prevented from falling down. The data collector 7 does not move in the vehicle and does not damage peripheral components and interior materials.

The electronic-components assembly 22, controlling the operation of the data collector 7, includes long and short boards, i.e. a main board 22a and a sub-board 22b. Each of the main board 22a and the sub-board 22b has electronic components such as a microprocessor and a memory. The two boards 22a and 22b are connected to each other via a connector board 22c provided between the boards. The main board 22a and the sub-board 22b are disposed in parallel to each other along the axial direction (vertical direction) of the case 21. The main board 22a and the sub-board 22b are disposed such that their lower ends have substantially the same position (height) in the axial direction. A slot 26 in which the flash memory card 25 is inserted from the bottom of the data collector 7 is provided between the main board 22a and the sub-board 22b.

The electronic-components assembly 22 of the data collector 7 includes a writer/reader, an interface, or a drive serving as a unit for writing/reading data into/from the external storage medium 25. The microprocessor provided on the main board 22a or on the sub-board 22b may control the writing/reading of data into/from the external storage medium.

The main board 22a and the sub-board 22b have different lengths. The short sub-board 22b has the connector 28a provided on its upper end portion. Through the connector 28a, a CAN signal is input to the electronic-components assembly 22. Fixed to the connector 28a is a metal fitting 27 used to connect a signal cable to the data collector 7. The electronic-components assembly 22 of the data collector 7 may include two connectors 28a corresponding to the first and second channels. The electronic-components assembly 22 further includes a terminal 28b for obtaining electric power from an external power source such as a cigarette-lighter socket in the compartment of the vehicle.

On the other hand, on the upper end portion of the main board 22a, three LEDs 29 of different colors, which indicate the operating condition of the data collector 7 are provided. A relationship between the lighting patterns of the LEDs 29 and the operating condition of the data collector 7 may be indicated, for example, by a label on the outer circumference surface of the case 21. A trigger switch 30 is disposed in the vicinity of the upper end portion of the main board 22a. When an operator presses the trigger switch 30 as required, the electronic-components assembly 22 starts to record CAN signals. Start and end of the recording of CAN signals may be controlled by using a time measuring unit or a timer provided for the data collector 7.

An upper panel 31 for covering upper ends of the main board 22a and the sub-board 22b is provided in the case 21. The upper panel 31 is formed in a step-like manner so as to correspond to a difference in length between the main board 22a and the sub-board 22b. The upper panel 31 includes a first semicircular plate 31a and a second semicircular plate 31b which are offset from each other in the axial direction of the case 21. The two semicircular plates 31a and 31b are aligned perpendicular to the axial direction of the case 21. The second semicircular plate 31b is disposed more inside than the first semicircular plate 31a in the case 21. Formed on the upper panel 31 are holes 32, 33, and 34 through which the connector 28a, the LEDs 29, and the trigger switch 30 are passed, and the connector 28a, the LEDs 29, and the trigger switch 30 are provided on the upper panel 31.

The main board 22a and the sub-board 22b are fixed to the case 21 via the upper panel 31 and a bottom panel 35 provided at bottom ends of the two boards. Accordingly, heat from the case 21 is hardly transmitted to the two boards, and thus the effect of the heat on the electronic components mounted on the boards is suppressed. Further, with the panels 31 and 35 provided at both the top and bottom ends, the entry of dust into the electronic-components assembly 22 is suppressed.

Data strings to be collected and stored by the data collector 7 can be digital data by the data converter 8, so a control state and behavior of a vehicle are efficiently analyzed. Further, data from the control units and the sensor is accumulated by the data collector 7 which is specialized in the function of data collection, so the data collector 7 is miniaturized.

The data collector 7 receives a signal from the CAN configured in the vehicle and stores data in the flash memory card 25. The recording of data is started when the operator turns on the trigger switch 30. Alternatively, when an input CAN signal is a predetermined setting signal, the recording of data is started. For example, the start and end of recording data is controlled by the presence or absence of predetermined date-and-time data output from the time measuring unit of the data collector 7. The recording of data may be performed by using a loop memory method so as to record data for a fixed period of time before a set data-recording start time and data for a fixed period of time after a set data-recording end time.

Further, the data collector 7 includes a counter or a timer to clarify a recording time in association with data recording, and can grasp a total time period from the activation of the data collector 7 or the number of times the engine starts, for example.

The data collector 7 may be activated by turning on any one of an ignition switch (when an ignition signal is contained in a CAN input signal), the trigger switch 30, and an accessory switch (when an ignition signal is not contained in a CAN input signal). Therefore, there is no need to provide a power switch for the data collector 7, enabling to cut down on costs and reduce weight of the data collector 7.

The data collector 7 is stopped by turning off any one of the switches, conversely to the activation operation. It is needless to say that recorded data is protected in the flash memory card 25 at the time of the stop of the data collector 7.

In the above-described embodiment, the data collector 7 is used with the CAN configured on the vehicle. However, not limited to this, the data collector 7 may be used with a network other than the CAN.

Although the invention has been described above by reference to certain embodiments of the invention, the invention is not limited to the embodiments described above. Modifications and variations of the embodiment described above will occur to those skilled in the art, in light of the above teachings. The scope of the invention is defined with reference to the following claims.

The entire contents of Japanese Patent Application P2004-250434 (filed Aug. 30, 2004) are incorporated herein by reference.

What is claimed is:

1. A data collector that collects a first data string sent by a control unit to a network according to a predetermined format, the control unit having a first identification number, and the first data string including the first identification number and a parameter which is used to control a vehicle or a vehicle component, the data collector comprising:
a first collecting means for collecting the first data string sent by the control unit; and
a second collecting means for collecting a second data string sent by a data converter, the data converter having a second identification number different from the first identification number of the control unit, the second data string conforming to the predetermined format;
wherein the data converter converts analog data sent from a sensor that detects a driving condition of the vehicle into digital data, puts the second identification number and the digital data in the second data string to be sent, and sends the second data string at a predetermined interval.

2. The data collector as defined in claim 1, further comprising a single storage medium that stores the first data string sent by the control unit and the second data string sent by the data converter.

3. The data collector as defined in claim 2, wherein the storage medium is a removable medium.

4. The data collector as defined in claim 1, further comprising a first storage medium to store the first data string sent by the control unit and a second storage medium to store the second data string sent by the data converter.

5. The data collector as defined in claim 4, wherein the first and second storage media are removable media.

6. The data collector as defined in claim 1, wherein the data converter converts analog data to digital data and digital data to analog data.

7. The data collector as defined in claim 1, wherein the data converter is formed separately from the data collector and is integrally connected to the data collector via a connector.

8. The data collector as defined in claim 1, wherein a sampling rate of the data converter for the analog data of the sensor is set faster than a sampling rate of the data collector for the second data string sent from the data converter.

9. The data collector as defined in claim 1, wherein the predetermined interval for sending the second data string is set according to a load of the network.

10. The data collector as defined in claim 1, wherein the predetermined format is a controller area network (CAN) format.

11. The data collector as defined in claim 1, further comprising:
a case having a substantially cylindrical shape;
an electronic-components assembly that controls an operation of the data collector and is accommodated in the case;
a panel fixed to the case, that has a first semicircular plate and a second semicircular plate which are offset from each other in an axial direction of the case, wherein the second semicircular plate is provided more inside than the first semicircular plate; and
a connector provided for the second semicircular plate of the panel.

12. The data collector as defined in claim 11, wherein the electronic-components assembly comprises:
a slot that accommodates a storage medium storing the first data string sent by the control unit and the second data string sent by the data converter; and
means for writing the first data string and/or the second data string into the storage medium.

13. The data collector as defined in claim 11, wherein the electronic-components assembly comprises a trigger switch that is used to start recording of the first data string sent by the control unit and the second data string sent by the data converter.

14. A data collector that collects data strings sent by a plurality of control units to a common network according to a predetermined format, each of the plurality of control units having a unique identification number, and each of the data strings including the identification number and a parameter which is used to control a vehicle or a vehicle component, the data collector comprising:
a first communicating means for communicating with the plurality of control units so as to collect the data strings sent by the plurality of control units; and
a second communicating means for communicating with a data converter so as to collect a data string sent by the data converter, the data converter having an identification number different from those of the plurality of control units, the data string conforming to the predetermined format;
wherein the data converter functions to: convert analog data sent from a sensor that detects a driving condition of the vehicle into digital data; put the identification number of the data converter and the digital data in the data string to be sent; and send the data string at a predetermined interval.

15. A data collector that collects a first data string sent by a control unit to a network according to a predetermined format, the control unit having a first identification number, and the first data string including the first identification number and a parameter which is used to control a vehicle or a vehicle component, the data collector comprising:
a first channel that collects the first data string sent by the control unit; and
a second channel that collects a second data string sent by a data converter, the data converter having a second identification number different from the first identification number of the control unit, the second data string conforming to the predetermined format;
wherein the data converter converts analog data sent from a sensor that detects a driving condition of the vehicle into digital data, puts the second identification number and the digital data in the second data string to be sent, and sends the second data string at a predetermined interval.

16. A network used in a vehicle, comprising:
a plurality of control units that connect with the network and send data strings according to a predetermined format to the network, each of the plurality of control units having a unique identification number and each of the data strings including the identification number and a parameter which is used to control the vehicle or a component of the vehicle;
a sensor that detects a driving condition of the vehicle;
a first channel that collects the data strings sent by the plurality of control units; and
a second channel that collects a data string sent by a data converter having an identification number different from those of the plurality of control units, the data string conforming to the predetermined format;
wherein the data converter converts analog data sent from the sensor into digital data, puts the identification number of the data converter and the digital data in the data string to be sent, and sends the data string to the second channel at a predetermined interval.
